(19) United States
(12) Patent Application Publication
(10) Pub. No.: US 2018/0215897 A1
(43) Pub. Date: Aug. 2, 2018

(54) POLYETHERIMIDE COMPOSITION FOR MOLDING

(71) Applicant: SABIC GLOBAL TECHNOLOGIES B.V., BERGEN OP ZOOM (NL)

(72) Inventors: Edward Venema, BERGEN OP ZOOM (NL); Laura Maria Unica Romero, CARTAGENA (ES); Carmen Rocío Misiego Arpa, GELEEN (NL); Antonius Leonardus Sacharias, BERGEN OP ZOOM (NL); Peter Catsman, BERGEN OP ZOOM (NL)

(21) Appl. No.: 15/747,600

(22) PCT Filed: Jul. 28, 2016
(86) PCT No.: PCT/IB2016/054523

§ 371 Date: Jan. 25, 2018

(30) Foreign Application Priority Data
Jul. 29, 2015 (EP) 15382398.4

(51) Int. Cl. C08K 5/11; C08G 73/10

(52) U.S. Cl. CPC C08K 5/11; C08K 2201/019; C08G 73/1071

(57) ABSTRACT

Disclosed herein is a composition comprising a polyetherimide comprising halogen-containing end groups, nitro-containing end groups, or a combination comprising halogen-containing end groups and nitro-containing end groups; and a tri(C₈₋₂₀ acyl) glyceride. Also disclosed is a method of making the composition.

### BACKGROUND

Polyetherimides are engineering thermoplastics which are often used in injection molding to make articles having high gloss. There are several different synthetic methods for making polyetherimides. One process for the manufacture of polyetherimides is by polymerization of alkali metal salts of dihydroxyaromatic compounds, such as bisphenol A disodium salt (“BPANa₂”), with a substituted bis(phthalimide) such as a bis(halophthalimide), a bis(nitrophthalimide) or a combination of bis(halophthalimide) and a bis(nitrophthalimide). A polyetherimide made by this method has halogen-containing end groups, nitro-containing end groups, or a combination of halogen-containing and nitro-containing end groups. Another process for the manufacture of polyetherimides is by polymerization of an aromatic bis(ether anhydride) or a chemical equivalent thereof with an organic diamine. A polyetherimide made by this method has acid end groups, amine end groups, or a combination of acid and amine end groups.

Even when the polyetherimides made by these two processes have the same structural units and similar molecular weights they can differ in some physical properties. There is a need to improve the interchangeability of the polyetherimides made by these processes.

### BRIEF DESCRIPTION

A composition comprising a polyetherimide comprising halogen-containing end groups, nitro-containing end groups, or a combination comprising halogen-containing end groups and nitro-containing end groups; and a tri(C₈₋₂₀ acyl) glyceride.

The composition can be made by combining the polyetherimide comprising halogen-containing end groups, nitro-containing end groups, or a combination comprising halogen-containing end groups and nitro-containing end groups with a tri(C₈₋₂₀ acyl) glyceride.

Articles comprising the composition are also described herein.

The above described and other features are exemplified by the following figures and detailed description.

### BRIEF DESCRIPTION OF THE DRAWINGS

Refer now to the figures, which are exemplary embodiments, and wherein the like elements are numbered alike.

FIGS. 1-3 are graphical representations of data from the Examples.

### DETAILED DESCRIPTION

Molding operations using a polyetherimide comprising halogen-containing end groups, nitro-containing end groups, or a combination comprising halogen-containing end groups and nitro-containing end groups has experienced difficulties, particularly when molding high gloss parts. After a short period of time molding operations must be halted so the mold can be cleaned due to the presence of surface defects, a loss of gloss, or both. Molding operations using a polyetherimide having acid end groups, amine end groups, or a combination of acid end groups and amine end groups does not experience the same issues. It was discovered that combining a tri(C₈₋₂₀ acyl) glyceride and a polyetherimide comprising halogen-containing end groups, nitro-containing end groups, or a combination comprising halogen-containing end groups and nitro-containing end groups resulted in a composition which functioned in molding operations in a manner similar to a polyetherimide having acid end groups, amine end groups, or a combination of acid end groups and amine end groups. Stated another way, the addition of a tri(C₈₋₂₀ acyl) glyceride to a polyetherimide comprising halogen-containing end groups, nitro-containing end groups, or a combination comprising halogen-containing end groups and nitro-containing end groups resolved the molding issues and allowed molding operations to continue at least four times longer between mold cleanings compared to molding operations using a polyetherimide comprising halogen-containing end groups, nitro-containing end groups, or a combination comprising halogen-containing end groups and nitro-containing end groups and no tri(C₈₋₂₀ acyl) glyceride. In addition the composition comprising the tri(C₈₋₂₀ acyl) glyceride has good light transmission at 800 nanometers and a melt stability similar to polyetherimide having acid end groups, amine end groups, or a combination of acid end groups and amine end groups.

A molded sample comprising the composition as described herein has 70 to 95% transmission at a wavelength of 800 nanometers (nm) and a thickness of 2.5 millimeters (mm). In some embodiments the composition has 75 to 90% transmission at a wavelength of 800 nm and a thickness of 2.5 mm. In some embodiments the composition has 80 to 87% transmission at a wavelength of 800 nm and a thickness of 2.5 mm.

The composition has good melt stability and has a change in melt viscosity of 0 to 15%, when maintained at 390° C. for 30 minutes at a constant shear in a nitrogen atmosphere. In some embodiments the composition has a change in melt viscosity of 5 to 15%, when maintained at 390° C. for 30 minutes at a constant shear in a nitrogen atmosphere.

Polyetherimides comprise more than 1, for example 2 to 1000, or 5 to 500, or 10 to 100 structural units of formula (1)

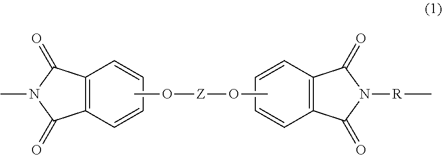

wherein each R is independently the same or different, and is a substituted or unsubstituted divalent organic group, such as a substituted or unsubstituted C₆₋₂₀ aromatic hydrocarbon group, a substituted or unsubstituted straight or branched chain C₄₋₂₀ alkylene group, a substituted or unsubstituted C₃₋₈ cycloalkylene group, in particular a halogenated derivative of any of the foregoing. In some embodiments R is divalent group of one or more of the following formulas (2)

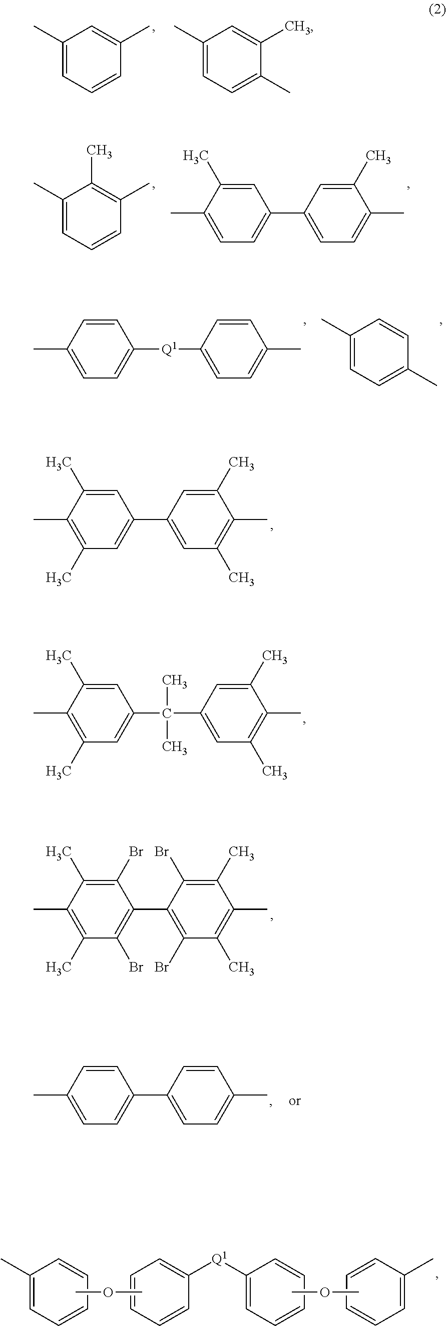

wherein Q¹ is —O—, —S—, —C(O)—, —SO₂—, —SO—, —P(R^{a})(═O)— wherein R^{a} is a C₁₋₈ alkyl or C₆₋₁₂ aryl, —C_{y}H_{2y}— wherein y is an integer from 1 to 5 or a halogenated derivative thereof (which includes perfluoroalkylene groups), or —(C₆H₁₀)_{z}— wherein z is an integer from 1 to 4. In some embodiments R is m-phenylene, p-phenylene, or a diarylene sulfone, in particular bis(4,4′-phenylene)sulfone, bis(3,4′-phenylene)sulfone, bis(3,3′-phenylene)sulfone, or a combination comprising at least one of the foregoing. In some embodiments, at least 10 mole percent of the R groups contain sulfone groups, and in other embodiments no R groups contain sulfone groups.

Exemplary groups Z include groups of formula (3)

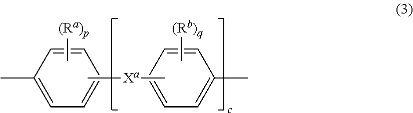

wherein R^{a} and R^{b} are each independently the same or different, and are a halogen atom or a monovalent C₁₋₆ alkyl group, for example; p and q are each independently integers of 0 to 4; c is 0 to 4; and X^{a} is a bridging group connecting the hydroxy-substituted aromatic groups, where the bridging group and the hydroxy substituent of each C₆ arylene group are disposed ortho, meta, or para (specifically para) to each other on the C₆ arylene group. The bridging group X^{a} can be a single bond, —O—, —S—, —S(O)—, —S(O)₂—, —C(O)—, or a C₁₋₁₈ organic bridging group. The C₁₋₁₈ organic bridging group can be cyclic or acyclic, aromatic or non-aromatic, and can further comprise heteroatoms such as halogens, oxygen, nitrogen, sulfur, silicon, or phosphorous. The C₁₋₁₈ organic group can be disposed such that the C₆ arylene groups connected thereto are each connected to a common alkylidene carbon or to different carbons of the C₁₋₁₈ organic bridging group. A specific example of a group Z is a divalent group of formula (3a)

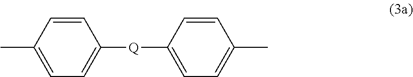

wherein Q is —O—, —S—, —C(O)—, —SO₂—, —SO—, —P(R^{a})(═O)— wherein R^{a} is a C₁₋₈ alkyl or C₆₋₁₂ aryl, or —C_{y}H_{2y}— wherein y is an integer from 1 to 5 or a halogenated derivative thereof (including a perfluoroalkylene group). In a specific embodiment Z is a derived from bisphenol A, such that Q in formula (3a) is 2,2-isopropylidene.

In an embodiment in formula (1), R is m-phenylene, p-phenylene, or a combination comprising at least one of the foregoing, and Z is a divalent group of formula (3a). Alternatively, R is m-phenylene, p-phenylene, or a combination comprising at least one of the foregoing, and Z is a divalent group of formula (3a) and Q is 2,2-isopropylidene. Alternatively, the polyetherimide can be a copolymer comprising additional structural polyetherimide units of formula (1) wherein at least 50 mole percent (mol %) of the R groups are bis(3,4′-phenylene)sulfone, bis(3,3′-phenylene)sulfone, or a combination comprising at least one of the foregoing and the remaining R groups are p-phenylene, m-phenylene or a combination comprising at least one of the foregoing; and Z is 2,2-(4-phenylene)isopropylidene, i.e., a bisphenol A moiety.

In some embodiments, the polyetherimide is a copolymer that optionally comprises additional structural imide units that are not polyetherimide units, for example imide units of formula (4)

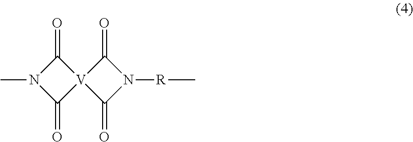

wherein R is as described in formula (1) and each V is the same or different, and is a substituted or unsubstituted C₆₋₂₀ aromatic hydrocarbon group, for example a tetravalent linker of the formulas

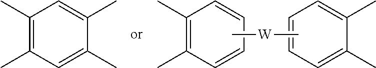

wherein W is a single bond, —O—, —S—, —C(O)—, —SO₂—, —SO—, —P(R^{a})(═O)— wherein R^{a} is a C₁₋₈ alkyl or C₆₋₁₂ aryl, or —C_{y}H_{2y}— wherein y is an integer from 1 to 5 or a halogenated derivative thereof (which includes perfluoroalkylene groups). These additional structural imide units preferably comprise less than 20 mol % of the total number of units, and more preferably can be present in amounts of 0 to 10 mol % of the total number of units, or 0 to 5 mol % of the total number of units, or 0 to 2 mole % of the total number of units. In some embodiments, no additional imide units are present in the polyetherimide.

The polyetherimide is made by reacting a substituted phthalic anhydride and an organic diamine wherein the substituted phthalic anhydride has a formula

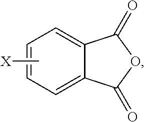

and the organic diamine has a formula

H₂N—R—NH₂

to provide a bis(phthalimide) of the formula

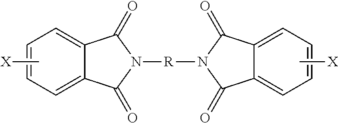

and polymerizing the bis(phthalimide) and an alkali metal salt of a dihydroxy aromatic compound of the formula

MO—Z—OM

wherein M is an alkali metal ion, to form the polyetherimide. The polyetherimide can comprise structural units of the formula

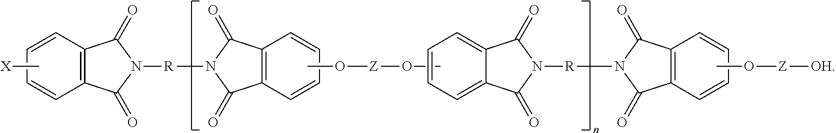

In the foregoing formulae X is fluoro, chloro, bromo, iodo, nitro, or a combination comprising at least one of the foregoing and n has a value of 1 to 40. R and Z are as defined above. It is also contemplated that the polyetherimide may have an OH content greater than 0 but less than or equal to 600 parts per million by weight (ppm). It is also contemplated that the polyetherimide may be endcapped. Useful endcapping agents include chlorophthalic anhydrides, phthalic anhydrides, substituted phthalic anhydrides, alkyl anhydrides, cyclic alkyl anhydrides, substituted aryl anhydrides, acyl alkyl halides, acyl aryl halides, aldehydes, ketones, esters, isocyanates, chloroformates, sulfonyl chlorides, aliphatic alcohols, salts of aliphatic alcohols, aromatic alcohols such as para cumyl phenol, salts of aromatic alcohols, and combinations thereof.

The polyetherimide can have a halogen content of 100 to 10,000 ppm. In some embodiments the polyetherimide has a halogen content of 200 to 4,000 ppm. In some embodiments the polyetherimide has a halogen content of 800 to 2500 ppm. In some embodiments the polyetherimide has a chloro content of 100 to 10,000 ppm, In some embodiments the polyetherimide has a chloro content of 200 to 4,000 ppm. In some embodiments the polyetherimide has a chloro content of 500 to 2500 ppm.

The polyetherimides can have a melt index of 0.1 to 10 grams per minute (g/min), as measured by American Society for Testing Materials (ASTM) D1238 at 340 to 370° C., using a 6.7 kilogram (kg) weight. In some embodiments, the polyetherimide has a weight average molecular weight (Mw) of 1,000 to 150,000 grams/mole (Dalton), as measured by gel permeation chromatography, using polystyrene standards. In some embodiments the polyetherimide has an Mw of 10,000 to 80,000 Daltons. In some embodiments the polyetherimide has an Mw of 40,000 to 60,000 Daltons. Such polyetherimides typically have an intrinsic viscosity greater than 0.2 deciliters per gram (dl/g), or, more specifically, 0.35 to 0.7 dl/g as measured in m-cresol at 25° C.

The composition further comprises a triacyl glyceride of formula (I)

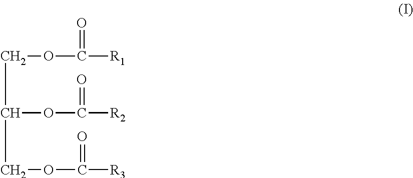

wherein R₁, R₂, and R₃ can be the same or different hydrocarbon chains with 8 to 20 carbon atoms and 0 to 6 unsaturations.

In some embodiments, R₁, R₂, and R₃ are independently selected from C₈-C₂₀ alkyl, C₈-C₂₀ haloalkyl, C₈-C₂₀ polyhaloalkyl, C₈-C₂₀ alkene, and C₈-C₂₀ alkoxy. In some embodiments, R₁, R₂, and R₃ are independently selected from C₁₇H₃₅ and in some embodiments are all C₁₇H₃₅.

The triacyl glyceride can be glycerol tristearate (GTS). GTS is a solid at room temperature with a melting point of 72 to 75° C., which facilitates handling.

The triacyl glyceride is present in an amount of 0.01 weight percent to 0.5 weight percent based on the combined weight of the polyetherimide and triacyl glyceride. Within this range, the triacyl glyceride can be present in an amount of 0.03 weight percent to 0.3 weight percent based on the combined weight of the polyetherimide and triacyl glyceride. In some embodiments, the triacyl glyceride is present in an amount of 0.05 weight percent to 0.25 weight percent based on the combined weight of the polyetherimide and triacyl glyceride.

The composition can be free of a release agent other than the triacyl glyceride. Examples of other release agents include monoacylglycerides such as glycerol monostearate; a poly-alpha olefin such as saturated poly(alpha) oligomer and saturated poly(1-decene) oligomer; linear low density polyethylene (LLDPE); acid esters such as dioctyl-4,5-epoxy-hexahydrophthalate; tris-(octoxycarbonylethyl)isocyanurate; epoxidized soybean oil; silicones, including silicone oils; esters, for example, fatty acid esters such as alkyl stearyl esters, e.g., methyl stearate, stearyl stearate, pentaerythritol tetrastearate, and the like; combinations of methyl stearate and hydrophilic and hydrophobic nonionic surfactants comprising polyethylene glycol polymers, polypropylene glycol polymers, poly(ethylene glycol-co-propylene glycol) copolymers, or a combination comprising at least one of the foregoing glycol polymers, e.g., methyl stearate and polyethylene-polypropylene glycol copolymer in a solvent; waxes such as beeswax, montan wax, and paraffin wax; alkyl amides of the structures (A) and (B) shown below, alkyl amides comprising primary amides, the C₁₋₆ N-alkyl amides and the, C₁₋₆ secondary amides of; linear or branched C₁₂₋₃₆ alkyl carboxylic acids, erucic acid, stearic acid, oleic acid, linoleic acid, linolenic acid, myristic acid, palmitic acid, arachidonic acid, behenic acid, lignoceric acid and C₆₋₂₀ bis amides of C₂₋₆ alkylene diamines or a combination of at least one of the foregoing alkyl amides;

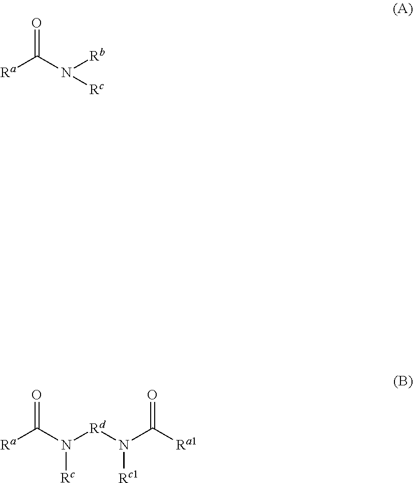

wherein R^{a} or R^{a1} are a C₁₋₃₀ alkyl group and R^{b}, R^{c}, and R^{c1} are independently H or a C₁₋₃₀ alkyl group and R^{d} is a C₂₋₆ alkyl group. The composition can comprise less than or equal to 0.01 weight percent, specifically, 0 weight percent of a total amount of release agent that is not the triacyl glyceride based on the total weight of the composition.

The composition can optionally include various additives ordinarily incorporated into polymer compositions of this type, with the proviso that the additive(s) are selected so as to not significantly adversely affect the desired properties of the thermoplastic composition, in particular the light transmission at 800 nm. Such additives can be mixed at a suitable time during the mixing of the components for forming the composition. Additives include impact modifiers, fillers, reinforcing agents, antioxidants, heat stabilizers, light stabilizers, ultraviolet (UV) light stabilizers, plasticizers, lubricants, antistatic agents, colorants such as such as titanium dioxide, carbon black, and organic dyes, surface effect additives, radiation stabilizers, flame retardants, and anti-drip agents. A combination of additives can be used, for example a combination of a heat stabilizer and ultraviolet light stabilizer. In general, the additives are used in the amounts generally known to be effective. For example, the total amount of the additives (other than any impact modifier, filler, or reinforcing agents) can be 0.01 to 5 wt. %, based on the total weight of the composition.

### EXAMPLES

The following examples were made using the materials in Table 1.

TABLE 1

| Component | Description |
|---|---|
| PEI-1 | A polyetherimide having amine endgroups and a weight |
| | average molecular weight of 40,000-60,000 Daltons as |
| | determined by gel permeation chromatography using |
| | polystyrene standards. This polyetherimide was made |
| | by the polymerization of bisphenol A dianhydride and |
| | a phenylene diamine. |
| PEI-2 | A polyetherimide having chloro end groups and a weight |
| | average molecular weight of 40,000-60,000 Daltons as |
| | determined by gel permeation chromatography using |
| | polystyrene standards. This polyetherimide was made |
| | by the polymerization of bisphenol A disodium salt |
| | and a bis(chlorophthalimide). |
| FC-1 | Tetrabutyl phosphonium perfluorobutyl sulfonate |
| Hydrotalcite | MgAl hydroxy carbonate hydrate |
| PETS | Pentaerythrityl tetrastearate |
| GTS | Glycerol tristearate |

Testing was performed in accordance with the methods in Table 2.

TABLE 2

| | | Method of measurement |
|---|---|---|
| Property | Units | (conditions) |
| Mechanical | | |
| Tensile Modulus | MPa | ISO-527 |
| Tensile Stress at Yield | MPa | ISO-527 |
| Tensile Stress at Break | MPa | ISO-527 |
| Tensile Strain at Yield | % | ISO-527 |
| Flexural modulus | MPa | ISO-178 |
| Flex strength at yield | MPa | ISO-178 |
| Flexural Max. stress | MPa | ISO-178 |
| Flexural Strain max | % | ISO-178 |
| stress | | |
| IZOD INI | KJ-P-M² | (4 mm, room temp, 5 kJ) |
| | | ISO-180 |
| IZOD un-notched | KJ-P-M² | (4 mm, room temperature) |
| | | ISO-180 |
| HDT - 0.45 MPa - Flat | ° C. | ISO-75 |
| HDT - 1.8 MPa - Flat | ° C. | ISO-75 |
| Flow properties | | |
| MVR | cm3/10 min | (337° C., 6.7 Kg, 300 |
| | | seconds) ISO-1133 |
| Rheology | | |
| MV, t = 0 sec | PaS | (390° C., N₂, 6.28 rad/seconds, |
| | | t = 0 sec) |
| MV, t = 1800 sec | PaS | (390° C., N₂, 6.28 rad/seconds, |
| | | t = 1800 sec) |
| Delta end/start | % | |
| Surface Quality | | |
| Metallization cross | NA | |
| Metallization corrosion | NA | |

### Examples 1-5

The polyetherimide was melt blended with the materials as shown in Table 3. The resulting compositions were tested for a range of physical properties according to the methods of Table 2. The polyetherimide alone was also tested. Results are shown in Table 3.

TABLE 3

| | Units | A* | 1* | 2* | 3 | 4* | 5* |
|---|---|---|---|---|---|---|---|
| PEI-1 | | 100 | — | — | — | — | |
| PEI-2 | Wt % | — | 99.5 | 99.9 | 99.9 | 99.9 | 99.8 |
| FC-1 | Wt % | — | 0.5 | — | — | — | |
| Hydrotalcite | Wt % | — | — | — | — | 0.1 | |
| PETS | Wt % | — | — | 0.1 | — | — | 0.2 |
| GTS | Wt % | — | — | — | 0.1 | — | |
| Mechanical properties | | | | | | | |
| Tensile Modulus | MPa | 3066 | 3052 | 3071 | 3083 | 3079 | 3059 |
| Tensile Stress @ Yield | MPa | 113 | 113 | 113 | 114 | 113 | 113 |
| Tensile Stress @ Break | MPa | 81 | 87 | 110 | 88 | 93 | 82 |
| Tensile Strain @ Yield | % | 7 | 7 | 7 | 7 | 7 | 7 |
| Flexural modulus | MPa | 3316 | 3146 | 3152 | 3170 | 3260 | 3196 |
| Flex strength at yield | MPa | 109 | 107 | 107 | 108 | 109 | 108 |
| Flexural Max. stress | MPa | 158 | 155 | 158 | 158 | 157 | 157 |
| Flexural Strain max stress | % | 9 | 8 | 9 | 8 | 8 | 8 |
| IZOD INI | KJ-P-M² | 4 | 4 | 4 | 5 | 3 | 4 |
| IZOD unnotched | KJ-P-M² | 109 | 99 | 104 | 109 | 110 | 112 |
| HDT-0.45 MPa-Flat | ° C. | 208 | 206 | 207 | 206 | 208 | 207 |
| HDT-1.8 MPa-Flat | ° C. | 193 | 190 | 193 | 193 | 194 | 193 |
| Flow properties | | | | | | | |
| MVR | cm³/10 min | 14 | 18 | 15 | 15 | 14 | 15 |
| Melt stability 390° C. | | | | | | | |
| MV, t = 0 sec | PaS | 610 | 307 | 516 | 459 | 522 | 500 |
| MV, t = 1800 sec | PaS | 639 | 116 | 528 | 412 | 565 | 498 |
| Delta end/start | % | 5 | −62 | 2 | −10 | 8 | 0 |
| Surface Quality | | | | | | | |
| Metallization cross | NA | OK | OK | OK | OK | OK | OK |
| Metallization corrosion | NA | OK | OK | OK | OK | OK | OK |

*Comparative example

The data in Table 3 shows that use of FC-1 was not an option because it resulted in a high decrease in viscosity during the melt stability test. Without being bound by theory, the decrease appears to be caused by a significant molecular weight breakdown of the polyetherimide in the presence of FC-1. The decrease in viscosity is shown by the large change (negative delta value).

None of the other additives showed negative effects on the desired properties.

### Examples 6-8

Examples 6-8 were manufactured in larger quantities than Examples 1-5. They were molded on a high gloss surface mold. Compositions are shown in Table 4. The time from the start of molding to the time when the mold needed cleaning was determined. The mold needed cleaning when the quality of the final part was affected. Results are shown in Table 5.

TABLE 4

| | Units | 6* | 7 | 8* |
|---|---|---|---|---|
| PEI-1 | | 49.9 | 49.9 | 49.95 |
| PEI-2 | Wt % | 50 | 50 | 50 |
| Hydrotalcite | Wt % | — | — | 0.05 |
| PETS | Wt % | 0.1 | — | — |
| GTS | Wt % | — | 0.1 | — |

TABLE 5

| | Time from start to mold cleaning |
|---|---|
| PEI-1* | Greater than 4 hours |
| PEI-2* | Less than 1 hour |
| Example 6* | 2 to 4 hours |
| Example 7 | Greater than 4 hours |
| Example 8* | 1 to 2 hours |

*Comparative example

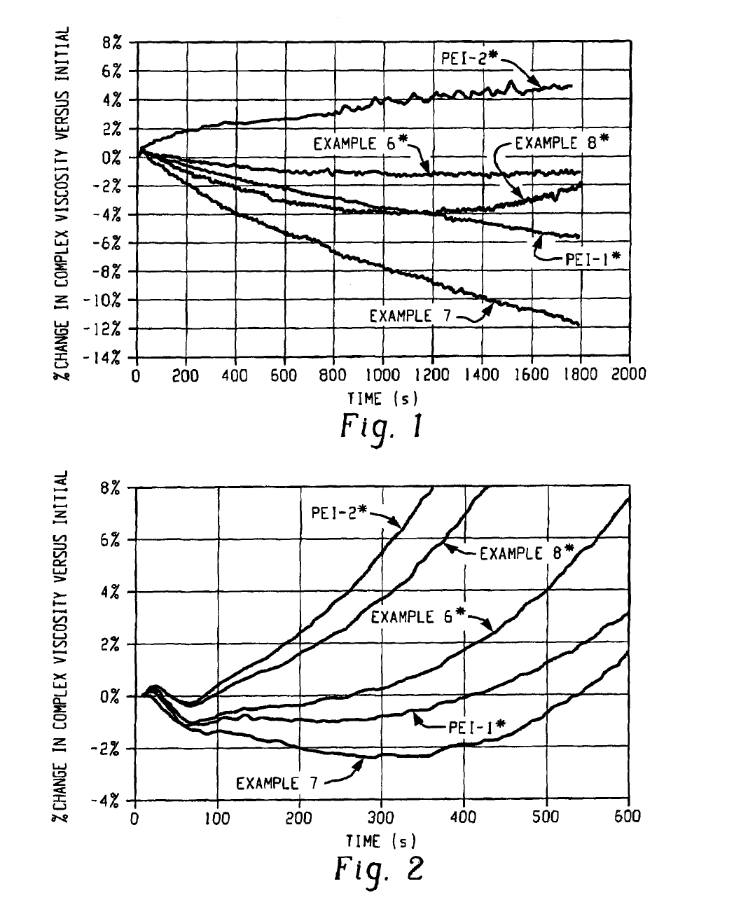

The rheology behavior (melt stability) of the compositions shown in Table 4 was examined by placing a small amount of material in a parallel plate rheometer at 390° C. in a nitrogen atmosphere and in normal atmosphere. For a 30 minute period the viscosity of the material was continuously measured under a fixed amount of shear to determine whether any significant change is taking place, indicating molecular weight loss or branching effects. Results are shown in FIG. 1 (nitrogen) and FIG. 2 (air).

The data in FIGS. 1 and 2 suggests that the triacyl glyceride (GTS) is not only acting as a release agent, but surprisingly also changing the rheology behavior of PEI, making it behave more like the comparative PEI-1*.

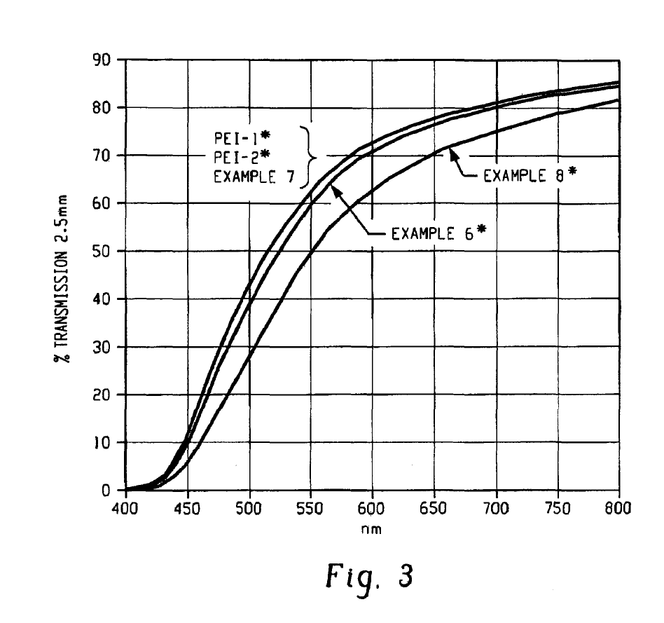

The UV-VIS-Near IR spectra of Examples 6-8 was measured on 2.5 mm thick plaques. Results are shown in FIG. 3.

As can be seen in FIG. 3, the material with triacyl glyceride (Example 7) has a high transmission equal to polyetherimide made by polymerizing a dianhydride and a diamine (PEI-1*).

The claims are further illustrated by the following Embodiments.

### Embodiment 1

A composition comprising a polyetherimide comprising halogen-containing end groups, nitro-containing end groups, or a combination comprising halogen-containing end groups and nitro-containing end groups; and a tri(C₈₋₂₀ acyl) glyceride.

### Embodiment 2

The composition of Embodiment 1, wherein the polyetherimide is of the formula

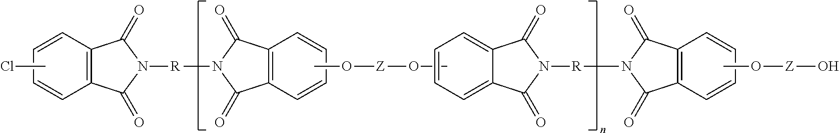

wherein each R is independently the same or different, and is s a substituted or unsubstituted C₆₋₂₀ aromatic hydrocarbon group, a substituted or unsubstituted straight or branched chain C₄₋₂₀ alkylene group, or a substituted or unsubstituted C₃₋₈ cycloalkylene group and Z is a group of formula (3)

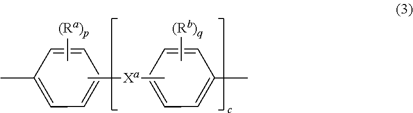

wherein R^{a} and R^{b} are each independently the same or different, and are a halogen atom or a monovalent C₁₋₆ alkyl group; p and q are each independently integers of 0 to 4; c is 0 to 4; and X^{a} is a single bond, —O—, —S—, —S(O)—, —S(O)₂—, —C(O)—, or a C₁₋₁₈ organic bridging group, and n has a value of 1 to 40.

### Embodiment 3

The composition of Embodiment 1, wherein each R is independently a divalent group of the formulae

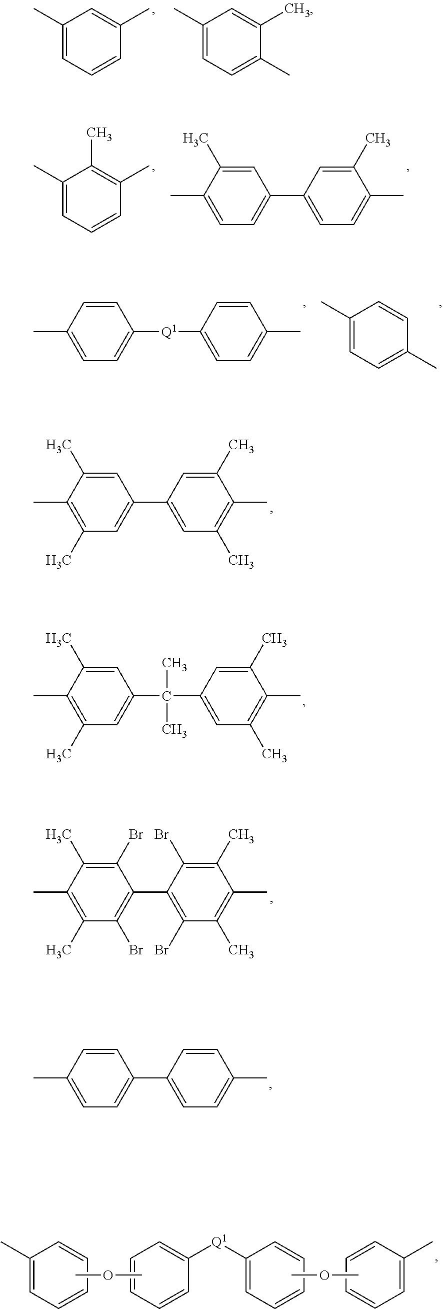

wherein Q¹ is —O—, —S—, —C(O)—, —SO₂—, —SO—, —C_{y}H_{2y}— wherein y is an integer from 1 to 5 or a halogenated derivative thereof (which includes perfluoroalkylene groups), or —(C₆H₁₀)_{z}— wherein z is an integer from 1 to 4

### Embodiment 4

The composition of Embodiment 3, wherein R is a phenyl group and Z is

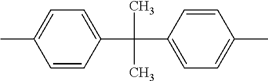

### Embodiment 5

The composition of any of Embodiments 1 to 4, wherein the polyetherimide has a chloro content of 500 to 2500 ppm.

### Embodiment 6

The composition of any of Embodiments 1 to 5 wherein the polyetherimide has a weight average molecular weight of 40,000 Daltons to 60,000 Daltons.

### Embodiment 7

The composition of any of Embodiments 1 to 6, wherein the polyetherimide is produced by polymerizing an alkali metal salt of a dihydroxy aromatic compound of the formula MO—Z—OM, wherein M is an alkali metal ion and Z is a divalent group of formula (3a)

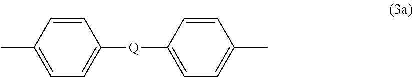

wherein Q is —O—, —S—, —C(O)—, —SO₂—, —SO—, —P(R^{a})(═O)— wherein R^{a} is a C₁₋₈ alkyl or C₆₋₁₂ aryl, or —C_{y}H_{2y}— wherein y is an integer from 1 to 5 or a halogenated derivative thereof and a bis(phthalimide) of the formula

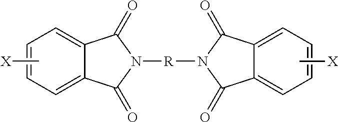

wherein R is divalent group of one or more of the following formulas (2)

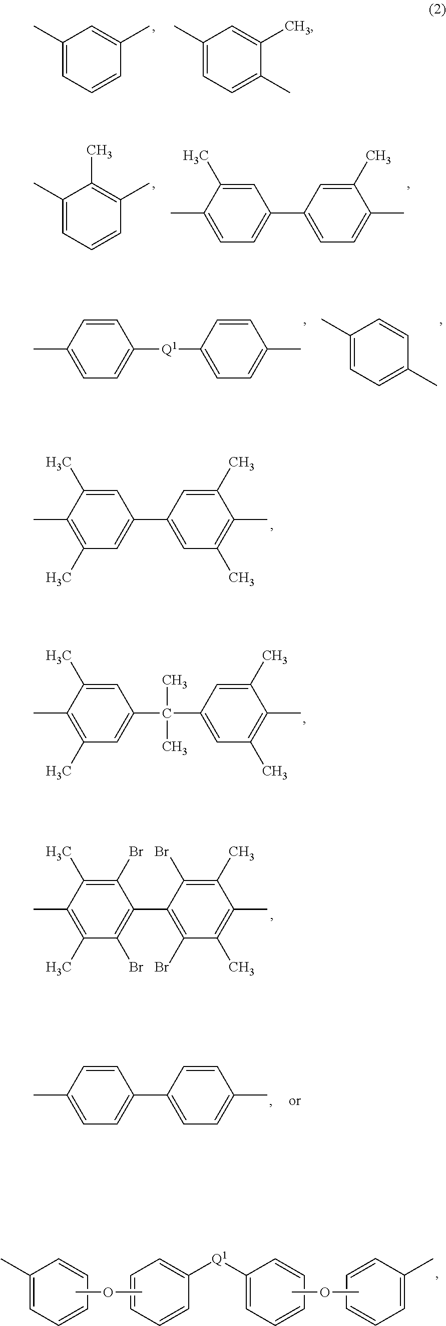

wherein Q¹ is —O—, —S—, —C(O)—, —SO₂—, —SO—, —P(R^{a})(═O)— wherein R^{a} is a C₁₋₈ alkyl or C₆₋₁₂ aryl, —C_{y}H_{2y}— wherein y is an integer from 1 to 5 or a halogenated derivative thereof and X is a halo or nitro group.

### Embodiment 8

The composition of any of Embodiments 1 to 7, wherein the composition is free of pentaerythrityl tetrastearate.

### Embodiment 9

The composition of any of Embodiments 1 to 8, wherein the triacyl glyceride is of the formula

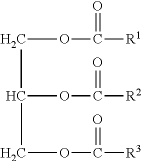

wherein each R¹, R², and R³ is independently a substituted or unsubstituted C₈₋₂₀ alkyl group optionally having 0 to 6 unsaturations.

### Embodiment 10

The composition of Embodiment 9, wherein each R¹, R², and R³ is independently C₈₋₂₀ alkyl group optionally substituted with one or more halogens, and optionally having 0 to 6 unsaturations.

### Embodiment 11

The composition of Embodiment 9, wherein the triacyl glyceride comprises glycerol tristearate.

### Embodiment 12

The composition of any of Embodiments 1 to 11 wherein the triacyl glyceride is present in an amount of 0.01 to 0.5 weight percent, based on the total weight of the polyetherimide.

### Embodiment 13

The composition of any of Embodiments 1 to 12, wherein a molded sample comprising the composition has 80 to 87% transmission at 800 nm when measured at a thickness of 2.5 millimeters.

### Embodiment 14

The composition of any of Embodiments 1 to 13, wherein a molded sample comprising the composition has 5% to 15% change in melt viscosity when maintained at 390° C. for 30 minutes at constant shear in a nitrogen atmosphere.

### Embodiment 15

An article comprising the composition of any of Embodiments 1 to 14.

### Embodiment 16

A method for the manufacture of the composition of any of Embodiment 1 to 14, the method comprising: combining the polyetherimide comprising halogen-containing end groups, nitro-containing end groups, or a combination comprising halogen-containing end groups and nitro-containing end groups and the a tri(C₈₋₂₀ acyl) glyceride.

As used herein, the term “hydrocarbyl” includes groups containing carbon, hydrogen, and optionally one or more heteroatoms (e.g., 1, 2, 3, or 4 atoms such as halogen, O, N, S, P, or Si). “Alkyl” means a branched or straight chain, saturated, monovalent hydrocarbon group, e.g., methyl, ethyl, i-propyl, and n-butyl. “Alkylene” means a straight or branched chain, saturated, divalent hydrocarbon group (e.g., methylene (—CH₂—) or propylene (—(CH₂)₃—)). “Alkenyl” and “alkenylene” mean a monovalent or divalent, respectively, straight or branched chain hydrocarbon group having at least one carbon-carbon double bond (e.g., ethenyl (—HC═CH₂) or propenylene (—HC(CH₃)═CH₂—). “Alkynyl” means a straight or branched chain, monovalent hydrocarbon group having at least one carbon-carbon triple bond (e.g., ethynyl). “Alkoxy” means an alkyl group linked via an oxygen (i.e., alkyl-O—), for example methoxy, ethoxy, and sec-butyloxy. “Cycloalkyl” and “cycloalkylene” mean a monovalent and divalent cyclic hydrocarbon group, respectively, of the formula —CₙH₂ₙ₋ₓ and —CₙH₂ₙ₋₂ₓ— wherein x is the number of cyclization(s). “Aryl” means a monovalent, monocyclic or polycyclic aromatic group (e.g., phenyl or naphthyl). “Arylene” means a divalent, monocyclic or polycyclic aromatic group (e.g., phenylene or naphthylene). “Arylene” means a divalent aryl group. “Alkylarylene” means an arylene group substituted with an alkyl group. “Arylalkylene” means an alkylene group substituted with an aryl group (e.g., benzyl). The prefix “halo” means a group or compound including one more halogen (F, Cl, Br, or I) substituents, which can be the same or different. The prefix “hetero” means a group or compound that includes at least one ring member that is a heteroatom (e.g., 1, 2, or 3 heteroatoms, wherein each heteroatom is independently N, O, S, or P.

“Substituted” means that the compound or group is substituted with at least one (e.g., 1, 2, 3, or 4) substituents instead of hydrogen, where each substituent is independently nitro (—NO₂), cyano (—CN), hydroxy (—OH), halogen, thiol (—SH), thiocyano (—SCN), C₁₋₆ alkyl, C₂₋₆ alkenyl, C₂₋₆ alkynyl, C₁₋₆ haloalkyl, C₁₋₉ alkoxy, C₁₋₆ haloalkoxy, C₃₋₁₂ cycloalkyl, C₅₋₁₈ cycloalkenyl, C₆₋₁₂ aryl, C₇₋₁₃ arylalkylene (e.g, benzyl), C₇₋₁₂ alkylarylene (e.g, toluyl), C₄₋₁₂ heterocycloalkyl, C₃₋₁₂ heteroaryl, C₁₋₆ alkyl sulfonyl (—S(═O)₂-alkyl), C₆₋₁₂ arylsulfonyl (—S(═O)₂-aryl), or tosyl (CH₃C₆H₄SO₂—), provided that the substituted atom's normal valence is not exceeded, and that the substitution does not significantly adversely affect the manufacture, stability, or desired property of the compound. When a compound is substituted, the indicated number of carbon atoms is the total number of carbon atoms in the group, including those of the substituent(s).

In general, the invention may alternately comprise, consist of, or consist essentially of, any appropriate components herein disclosed. The invention may additionally, or alternatively, be formulated so as to be devoid, or substantially free, of any components, materials, ingredients, adjuvants or species used in the prior art compositions or that are otherwise not necessary to the achievement of the function and/or objectives of the present invention.

All ranges disclosed herein are inclusive of the endpoints, and the endpoints are independently combinable with each other (e.g., ranges of “up to 25 wt. %, or, more specifically, 5 wt. % to 20 wt. %”, is inclusive of the endpoints and all intermediate values of the ranges of “5 wt. % to 25 wt. %,” etc.). “Or” means “and/or”. “Combination” is inclusive of blends, mixtures, alloys, reaction products, and the like. Furthermore, the terms “first,” “second,” and the like, herein do not denote any order, quantity, or importance, but rather are used to denote one element from another. The terms “a” and “an” and “the” herein do not denote a limitation of quantity, and are to be construed to cover both the singular and the plural, unless otherwise indicated herein or clearly contradicted by context. The suffix “(s)” as used herein is intended to include both the singular and the plural of the term that it modifies, thereby including one or more of that term (e.g., the film(s) includes one or more films). Reference throughout the specification to “one embodiment”, “another embodiment”, “an embodiment”, and so forth, means that a particular element (e.g., feature, structure, and/or characteristic) described in connection with the embodiment is included in at least one embodiment described herein, and may or may not be present in other embodiments. In addition, it is to be understood that the described elements may be combined in any suitable manner in the various embodiments.

While particular embodiments have been described, alternatives, modifications, variations, improvements, and substantial equivalents that are or may be presently unforeseen may arise to applicants or others skilled in the art. Accordingly, the appended claims as filed and as they may be amended are intended to embrace all such alternatives, modifications variations, improvements, and substantial equivalents.

1. A composition comprising
a polyetherimide comprising halogen-containing end groups, nitro-containing end groups, or a combination comprising halogen-containing end groups and nitro-containing end groups; and
a tri(C₈₋₂₀ acyl) glyceride.

2. The composition of claim 1, wherein the polyetherimide is of the formula 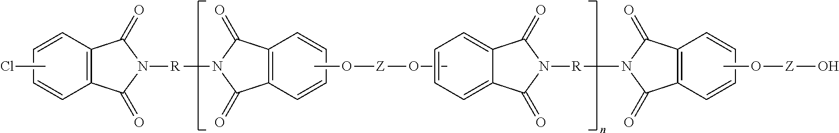
wherein
each R is independently the same or different, and is s a substituted or unsubstituted C₆₋₂₀ aromatic hydrocarbon group, a substituted or unsubstituted straight or branched chain C₄₋₂₀ alkylene group, or a substituted or unsubstituted C₃₋₈ cycloalkylene group and
Z is a group of formula (3) 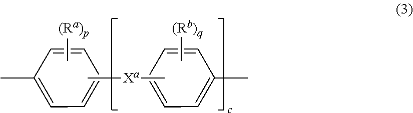
wherein R^{a} and R^{b} are each independently the same or different, and are a halogen atom or a monovalent C₁₋₆ alkyl group; p and q are each independently integers of 0 to 4; c is 0 to 4; and X^{a} is a single bond, —O—, —S—, —S(O)—, —S(O)₂—, —C(O)—, or a C₁₋₁₈ organic bridging group, and n has a value of 1 to 40.

3. The composition of claim 1, wherein
each R is independently a divalent group of the formulae 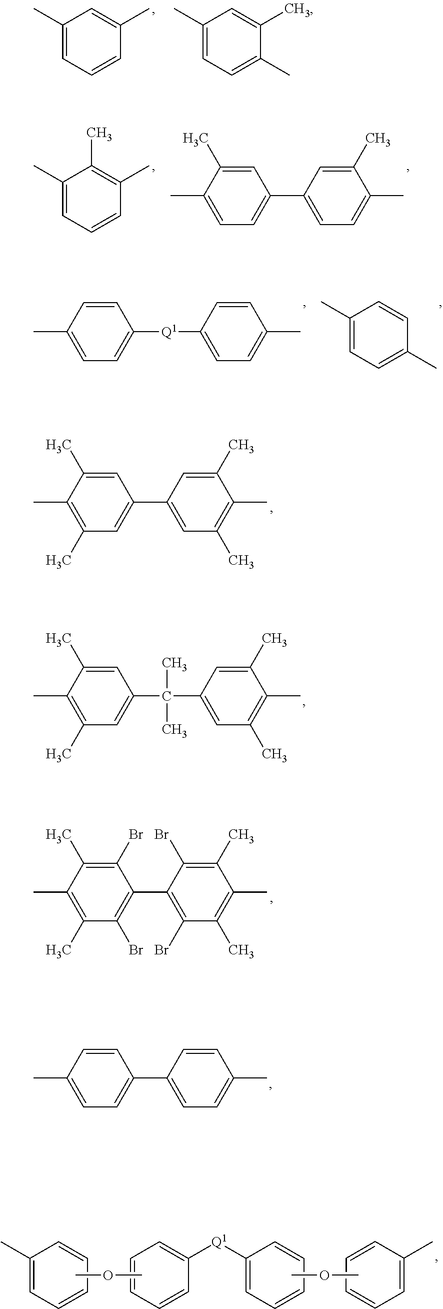
wherein Q¹ is —O—, —S—, —C(O)—, —SO₂—, —SO—, —C_{y}H_{2y}— wherein y is an integer from 1 to 5 or a halogenated derivative thereof, or —(C₆H₁₀)_{z}— wherein z is an integer from 1 to 4

4. The composition of claim 3, wherein R is a phenyl group and Z is

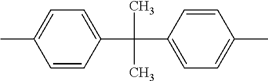

5. The composition of claim 1, wherein the polyetherimide has a chloro content of 500 to 2500 ppm.

6. The composition of claim 1, wherein the polyetherimide has a weight average molecular weight of 40,000 Daltons to 60,000 Daltons.

7. The composition of claim 1, wherein the polyetherimide is produced by polymerizing an alkali metal salt of a dihydroxy aromatic compound of the formula
MO—Z—OM
wherein M is an alkali metal ion and Z is a divalent group of formula (3a) 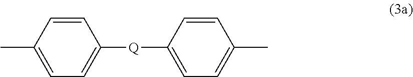
wherein Q is —O—, —S—, —C(O)—, —SO₂—, —SO—, —P(R^{a})(═O)— wherein R^{a} is a C₁₋₈ alkyl or C₆₋₁₂ aryl, or —C_{y}H_{2y}— wherein y is an integer from 1 to 5 or a halogenated derivative thereof and a bis(phthalimide) of the formula 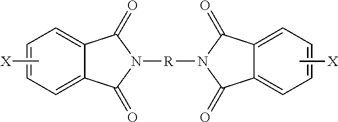
wherein R is divalent group of one or more of the following formulas (2) 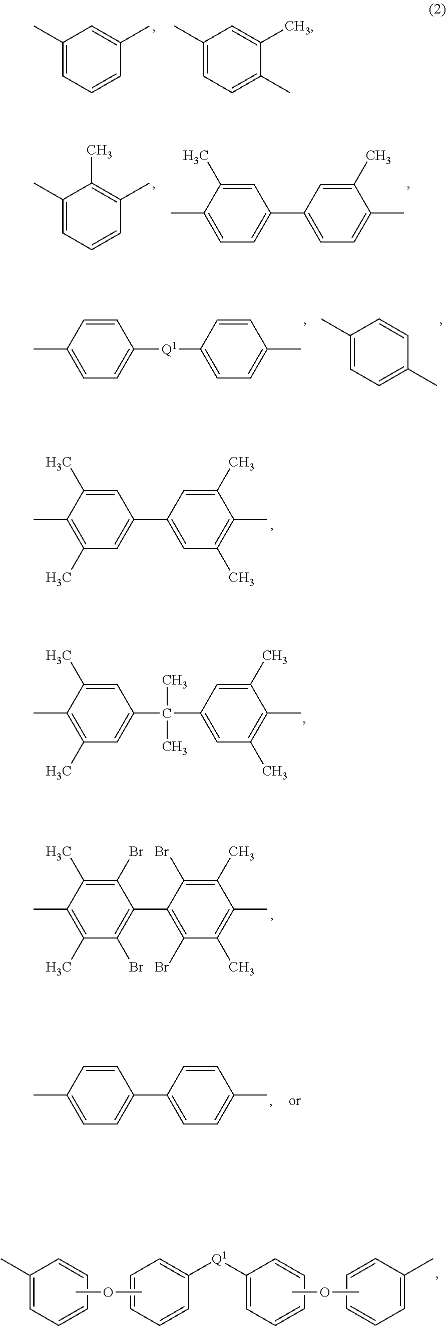
wherein Q¹ is —O—, —S—, —C(O)—, —SO₂—, —SO—, —P(R^{a})(═O)— wherein R^{a} is a C₁₋₈ alkyl or C₆₋₁₂ aryl, —C_{y}H_{2y}— wherein y is an integer from 1 to 5 or a halogenated derivative thereof and X is a halo or nitro group.

8. The composition of claim 1, wherein the composition is free of pentaerythrityl tetrastearate.

9. The composition of claim 1, wherein the triacyl glyceride is of the formula 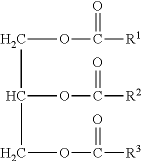
wherein each R¹, R², and R³ is independently a substituted or unsubstituted C₈₋₂₀ alkyl group optionally having 0 to 6 unsaturations.

10. The composition of claim 9, wherein each R¹, R², and R³ is independently C₈₋₂₀ alkyl group optionally substituted with one or more halogens, and optionally having 0 to 6 unsaturations.

11. The composition of claim 9, wherein the triacyl glyceride comprises glycerol tristearate.

12. The composition of claim 1, wherein the triacyl glyceride is present in an amount of 0.01 to 0.5 weight percent, based on the total weight of the polyetherimide.

13. The composition of any claim 1, wherein a molded sample comprising the composition has 80 to 87% transmission at 800 nm when measured at a thickness of 2.5 millimeters.

14. The composition of claim 1, wherein a molded sample comprising the composition has 5% to 15% change in melt viscosity when maintained at 390° C. for 30 minutes at constant shear in a nitrogen atmosphere.

15. An article comprising the composition of claim 1.

16. A method for the manufacture of the composition of claim 1, the method comprising:
combining the polyetherimide comprising halogen-containing end groups, nitro-containing end groups, or a combination comprising halogen-containing end groups and nitro-containing end groups and the a tri(C₈₋₂₀ acyl) glyceride.
